(19) United States
(12) Patent Application Publication
(10) Pub. No.: US 2025/0209503 A1
(43) Pub. Date: Jun. 26, 2025

(54) CONTROL DEVICE, NON-TRANSITORY COMPUTER-READABLE RECORDING MEDIUM STORING COMPUTER-READABLE INSTRUCTIONS FOR CONTROL DEVICE, AND METHOD EXECUTED BY CONTROL DEVICE

(71) Applicant: BROTHER KOGYO KABUSHIKI KAISHA, Nagoya (JP)

(72) Inventor: Shuhei KATO, Nagoya (JP)

(21) Appl. No.: 18/990,193

(22) Filed: Dec. 20, 2024

(30) Foreign Application Priority Data
Dec. 26, 2023 (JP) 2023-219851

(51) Int. Cl. G06Q 30/0283; G06K 15/00

(52) U.S. Cl. CPC G06Q 30/0283; G06K 15/002

(57) ABSTRACT

A control device may include a controller configured to: calculate a plurality of print costs corresponding to a plurality of print plans by using print history information of a printer in a predetermined period, the predetermined period being a period during which a predetermined service related to the printer is used by a user but the user is not charged a usage fee for the predetermined service; display, on a display, a selection screen including related information which is related to the plurality of calculated print costs; and in a case where a first print plan among the plurality of print plans is selected on the selection screen, execute a first charge process for charging the user a first print cost corresponding to the first print plan among the plurality of calculated print costs.

### REFERENCE TO RELATED APPLICATIONS

This application claims priority from Japanese Patent Application No. 2023-219851 filed on Dec. 26, 2023. The entire content of the priority application is incorporated herein by reference.

### BACKGROUND ART

An art configured to calculate a plurality of fees corresponding to a plurality of fee plans by using log information of image processing executed by an image processing device and presenting a lowest fee plan to a user is known.

### SUMMARY

The present teachings disclose an art configured to improve user convenience.

A control device disclosed herein may comprise a controller, wherein the controller is configured to: calculate a plurality of print costs corresponding to a plurality of print plans by using print history information of a printer in a predetermined period, wherein the predetermined period is a period during which a predetermined service related to the printer is used by a user but the user is not charged a usage fee for the predetermined service; display, on a display, a selection screen including related information which is related to the plurality of calculated print costs, the selection screen being for selecting one print plan from among the plurality of print plans; and in a case where a first print plan among the plurality of print plans is selected on the selection screen, execute a first charge process for charging the user a first print cost corresponding to the first print plan among the plurality of calculated print costs.

According to the above configuration, the user can use the predetermined service related to the printer while the usage fee is not charged in the above-mentioned predetermined period, that is, in a so-called a trial period. Due to this, user convenience can be improved.

A computer program for realizing the above-described control device and a non-transitory computer-readable storage medium storing computer-readable instructions for the control device are also novel and useful. Further, a method executed by the above-described control device is also novel and useful. Yet further, a communication system comprising the above-mentioned control device and another device (e.g., printer, terminal device) is also novel and useful.

### BRIEF DESCRIPTION OF DRAWINGS

FIG. 1 illustrates a configuration of a communication system.

FIG. 2 illustrates an example of tables.

FIG. 3 illustrates a sequence diagram of processes executed by respective devices.

FIG. 4 illustrates a diagram for describing a method of calculating print costs.

FIG. 5 illustrates a result screen.

### DESCRIPTION

### First Embodiment

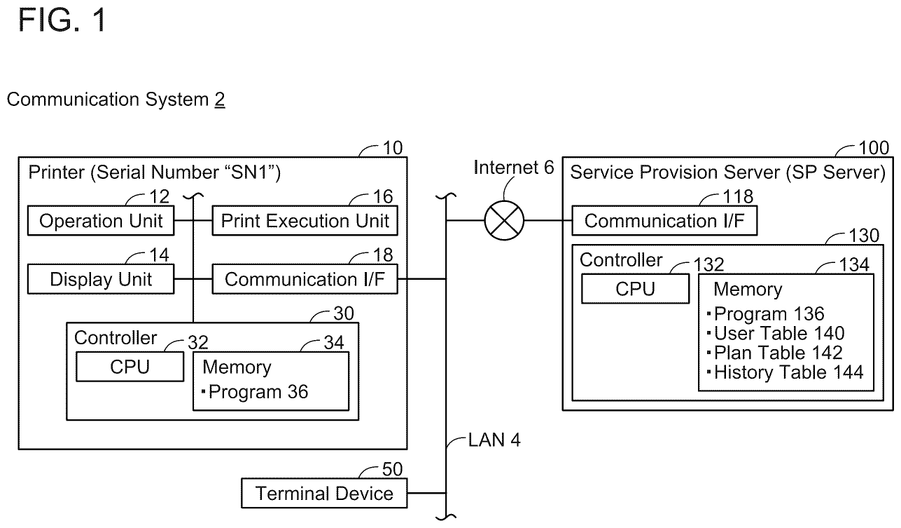

### (Configuration of Communication System 2; FIG. 1)

As illustrated in FIG. 1, a communication system 2 comprises a printer 10, a terminal device 50, and a service provision server 100. The printer 10 and the terminal device 50 are connected to a Local Area Network (LAN) 4 and are configured to communicate with each other via the LAN 4. The terminal device 50 may be a mobile terminal device such as a mobile phone (e.g., smartphone), a PDA, a laptop PC, and a tablet PC or may be a stationary terminal device such as a desktop PC. The LAN 4 is connected to the Internet 6. The service provision server 100 is connected to the Internet 6. Hereafter, the service provision server 100 will be referred to as “Service Provision (SP) server”.

### (Configuration of Printer 10)

The printer 10 is a peripheral device configured to execute a print function (that is, a peripheral device for the terminal device 50, for example). The printer 10 may be a multi-function peripheral configured to execute a scan function, a facsimile function for example, in addition to the print function. The printer 10 has a serial number “SN1”. The serial number is an identification number assigned when the printer is manufactured.

The printer 10 comprises an operation unit 12, a display unit 14, a print execution unit 16, a communication interface 18, and a controller 30. The operation unit 12 is a user interface for the user to input various information to the printer 10. The operation unit 12 comprises a touch panel for displaying software key(s) (operation object(s)), hardware key(s), or a combination thereof, for example. The display unit 14 is a display or a panel for displaying various information. The panel may be a liquid crystal panel or an organic EL panel, and may be or may not be a touch panel. The print execution unit 16 comprises a print engine of an inkjet scheme, an electrophotography scheme, or a thermal scheme. The communication interface 18 is connected to the LAN 4. The communication interface 18 may be an interface configured to execute wireless communication and/or may be an interface configured to execute wired communication.

The controller 30 comprises a CPU 32 and a memory 34. The memory 34 comprises a volatile memory and a non-volatile memory. The volatile memory includes a RAM and cache memory. The non-volatile memory may be a ROM, a flash memory, a solid state drive (SSD), a hard disk drive (HDD), or a combination thereof. The non-volatile memory stores a program 36. The program 36 stored in the non-volatile memory is loaded to the volatile memory, and the program 36 is executed by the CPU 32, by which various kinds of processes are realized.

### (Configuration of SP Server 100)

The SP server 100 is disposed on the Internet 6 by a vendor of the printer 10. In a modification, the SP server 100 may be disposed on the Internet 6 by an entity different from the above-mentioned vendor. In another modification, the above-mentioned vendor may not prepare a hardware of the SP server 100, but may utilize an environment provided by an external cloud computing service. In this case, the above-mentioned vendor prepares a program (software) for realizing the SP server 100, and introduces the same in the above environment. The SP server 100 may be a single server, or may be a collection of plural servers.

The SP server 100 provides a subscription service related to a printer. In the subscription service, only a basic fee is charged if a number of printed sheets within a unit period (e.g., one month) is equal to or less than an upper limit number of printed sheets (e.g., 100 sheets), and if the number of printed sheets exceeds the upper limit number of printed sheets, a sum of the basic fee and an excess fee according to the number of printed sheets exceeding the upper limit number of printed sheets is charged. The subscription service includes an automatic shipping service in which a new cartridge is automatically shipped when a remaining level of color material (e.g., ink, toner) within a color cartridge mounted in a printer is equal to or less than a predetermined remaining level. A fee for the cartridge is included in the basic fee of the subscription service. Hereafter, the color cartridge will be described as “CTG”.

The SP server 100 comprises a communication interface 118 and a controller 130. The communication interface 118 is connected to the Internet 6. The controller 130 comprises a CPU 132 and a memory 134. The CPU 132 executes various processes in accordance with a program 136 stored in the memory 134. The memory 134 comprises a volatile memory and a non-volatile memory. Details of the memory 134 are the same as the memory 34 of the printer 10. The program 136 stored in the non-volatile memory is loaded to the volatile memory, and the program 136 is executed by the CPU 132, by which various processes are realized. The memory 134 further stores a user table 140, a plan table 142, and a history table 144.

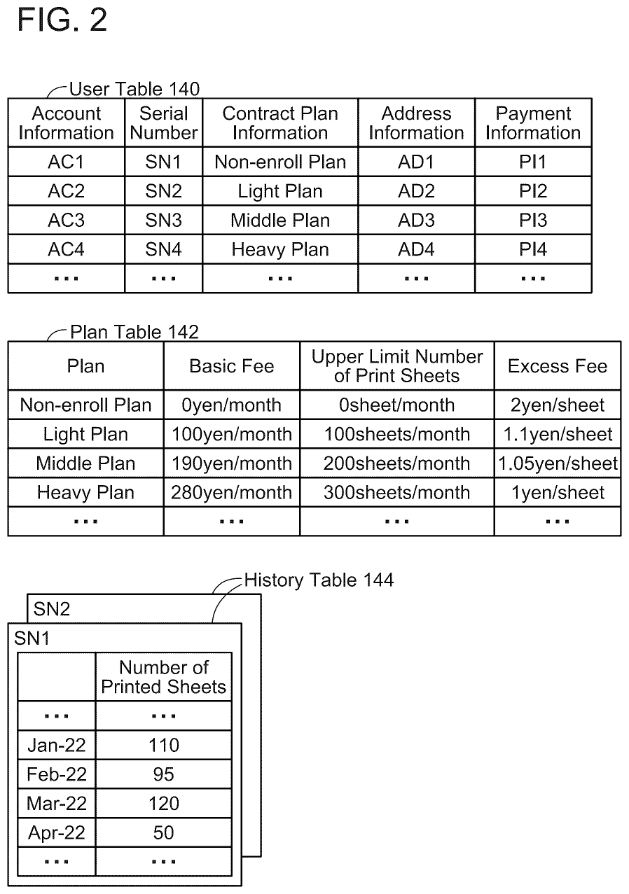

### (Contents of Tables 140, 142, 144; FIG. 2)

With reference to FIG. 2, contents of the respective tables 140, 142, and 144 will be described. In the user table 140, account information, a serial number, contract plan information, address information, and payment information are stored in association with each other. The account information is for the user to log in the SP server 100, and thus includes a user ID and a password. The serial number is a serial number of a printer used by the user. The contract plan information is information indicating a plan of the subscription service contracted by the user, and is one of a non-enrollment plan, a light plan, a middle plan, and a heavy plan. Here, although this is not illustrated in FIG. 2, a trial plan in which a usage fee is charged to the user retrospectively also exists. The address information is information indicating an address to which the CTG is to be shipped. The payment information is information for the user to pay the usage fee of the subscription service, and for example is card numbers and an expiration date of a credit card.

When the user access the SP server 100 by using a terminal device (e.g., 50) and inputs the account information (e.g., “AC1”), the address information (e.g., “AD1”), and the payment information (e.g., “PI1”), these information are stored in the user table 140. Here, when the user performs a predetermined operation on the printer 10 at this occasion, communication is executed between the printer 10 and the SP server 100, and the serial number “SN1” of the printer 10 is sent from the printer 10 to the SP server 100. The SP server 100 stores the serial number “SN1” in association with the account information “AC1”. Further, the user can select the plan of the subscription service in a state of logging in the SP server 100. Due to this, the SP server 100 stores the contract plan information in association with the account information “AC1”. The SP server 100 stores the non-enrollment plan as the contract plan information while the user has not enrolled in the subscription service.

In the plan table 142, a plan type, the basic fee, the upper limit number of printed sheets, and the excess fee are stored in association with each other. The plan type is one of the non-enrollment plan, the light plan, the middle plan, and the heavy plan. The non-enrollment plan means not having enrolled in the subscription service, that is, means that a contract for the subscription service has not been made. The light plan is for a user with a relatively small usage of the printer (i.e., light user). The heavy plan is for a user with a relatively large usage of the printer (i.e., heavy user). The middle plan is for a user with a usage that is neither small nor large, that is, for a user between the light user and the heavy user (i.e., middle user).

In the subscription service according to the present embodiment, the usage fee is charged to the user at every unit period, which is one month. The basic fee is a fee required for one month. The upper limit number of printed sheets is an upper limit number of sheets of a print medium that can be printed at the basic fee within one month. The excess fee is a fee per one printed sheet if the number of printed sheets exceeds the upper limit number of printed sheets. The followings have been determined in advance for the light plan, the middle plan, and the heavy plan. The basic fee “100 yen” for the light plan is the lowest, and the basic fee for the heavy plan is highest. The upper limit number of printed sheets “100 sheets” for the light plan is the smallest, and the upper limit number of printed sheets “300 sheets” for the heavy plan is the most. The excess fee “1.1 yen” for the light plan is the highest, and the excess fee “1 yen” for the heavy plan is the lowest. Because the non-enrollment plan means not enrolling in the subscription service, the basic fee and the upper limit number of printed sheets are both zero. The excess fee “2 yen” for the non-enrollment plan is a fee required per one printed sheet according to the user purchasing the CTG by himself/herself. The vendor of the printer has each of the fees prestored in the plan table 142. In particular, the vendor calculates the fee per printed sheet “2 yen” based on the price of the CTG, and has the fee “2 yen” stored as the excess fee for the non-enrollment plan.

In the history table 144, for every serial number of the printer, the month and the number of printed sheets are stored in association with each other. The printer sends periodically (e.g., every day, every one hour) the serial number of the printer and an accumulated number of printed sheets to the SP server 100. Due to this, the SP server 100 can calculate the number of printed sheets of one month and store the same.

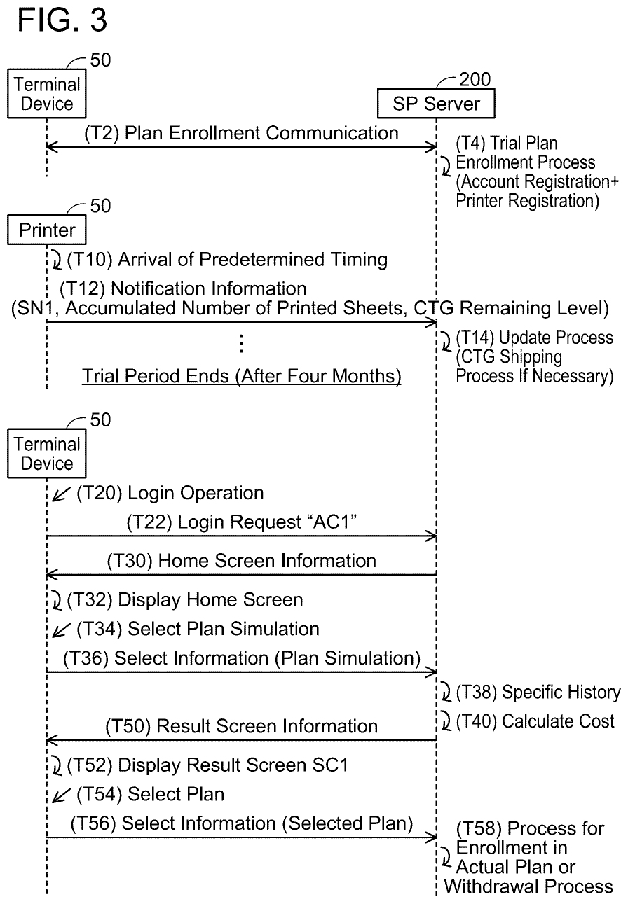

### (Processes Executed by Respective Devices; FIG. 3)

Next, with reference to FIG. 3, processes executed by the respective devices 10, 50, and 100 will be described. In the following description, for easier understanding, operations realized by the CPU (e.g., CPU 32, 132) of each device will be described with each device (e.g., the printer 10, the terminal device 50, the SP server 100) as a subject of action, without describing them with the CPU as a subject of action.

The user of the printer 10 performs an operation for enrolling in the trial plan on the terminal device 50. Due to this, in T2, plan enrollment communication is executed between the terminal device 50 and the SP server 100. The plan enrollment communication includes communication of each information inputted to the terminal device 50, that is, the account information “AC1”, the address information “AD1”, and the payment information “PI1”. Although this is not illustrated, at this occasion, in response to the user performing the predetermined operation on the printer 10, communication is executed between the printer 10 and the SP server 100, by which the serial number “SN1” of the printer 10 is sent from the printer 10 to the SP server 100.

The user performs an operation for enrolling in the trial plan on the terminal device 50. In this case, the plan enrollment communication includes communication of information indicating that the trial plan has been selected. Here, the trial plan is a plan for which the usage fee is not charged to the user during a trial period (four months in the present embodiment) but the CTG automatic shipping service is provided. The usage fee for the trial period will be retrospectively charged to the user after the trial period has ended.

In T4, the SP server 100 executes a trial plan enrollment process. Specifically, the SP server 100 stores the account information “AC1”, the contract plan information “trial plan”, the serial number “SN1”, the address information “AD1”, and the payment information “PI1” in association with each other in the user table 140 (see FIG. 2).

When the printer 10 determines that a predetermined timing has arrived in T10, in T12 the printer 10 sends notification information to the SP server 100. The predetermined timing is for example a predetermined time in a day. The notification information includes the serial number “SN1” of the printer 10, the accumulated number of printed sheets, and the remaining level of color material within the current color CTG (hereafter, “CTG remaining level”).

When the SP server 100 receives the notification information from the printer 10 in T12, the SP server 100 updates the history table 144 by using information in the notification information in T14. Specifically, the SP server 100 has the notification information previously received from the printer 10 stored therein. The SP server 100 calculates a different between the accumulated number of printed sheets in the notification information received this time and the accumulated number of printed sheets in the notification information previously received, and adds the difference to the number of printed sheets of this month associated with the serial number “SN1”.

In a case where the user of the printer 10 has enrolled in the subscription service (including the trial plan), the SP server 100 determines whether the CTG remaining level in the notification information is equal to or less than the predetermined remaining level or not. In a case where the SP server 100 determines that the CTG remaining level is equal to or less than the predetermined remaining level, in T14 the SP server 100 ships a new CTG. Specifically, the SP server 100 specifies the address information “AD1” associated with the serial number “SN1” in the notification information from the user table 140, and outputs an instruction for shipping the new CTG with the address information “AD1” as a destination. The outputting of such instruction includes sending the instruction to a terminal of a person who ships the CTG. In a modification, the outputting of the instruction includes sending the instruction to a shipment server configured separately from the SP server 100, for example.

The printer 10 executes the process of T12 repeatedly (e.g., periodically such as every one hour). As such, the SP server 100 executes the process of T14 repeatedly.

The SP server 100 calculates a usage fee according to the enrolled plan and the number of printed sheets of one month of the printer 10 by using the basic fee, the upper limit number of printed sheets, and the excess fee all stored in the plan table 142. Then, the SP server 100 charges the user the calculated usage fee by using the payment information “PI1” (e.g., credit card information). In the case of FIG. 3 however, since the user has enrolled in the trial plan, the user is not charged the usage fee during the trial period. That is, the user can be provided with the CTG automatic shipping service without being charged the usage fee during the trial period.

After the trial period ends, in T20 the terminal device 50 receives a login operation to the SP server 100 from the user. The login operation includes inputting of the account information “AC1”. In T22, the terminal device 50 sends a login request including the account information “AC1” to the SP server 100.

When the SP server 100 receives the login request from the terminal device 50 in T22, the SP server 100 authenticates the account information “AC1” included in the login request. The authentication succeeds in the present case, and thus in T30 the SP server 100 sends home screen information representing a home screen to the terminal device 50.

When the terminal device 50 receives the home screen information from the SP server 100 in T30, the terminal device 50 displays the home screen in T32. The home screen includes a plurality of icons indicating various services which the SP server 100 can provide. The plurality of icons includes an icon indicating simulation for selecting the subscription plan. When the terminal device 50 receives selection of such icon from the user in T34, the terminal device 50 sends selection information indicating the plan simulation to the SP server 100 in T36.

When the SP server 100 receives the selection information from the terminal device 50 in T36, the SP server 100 firstly specifies the serial number “SN1” associated with the logged-in account information “AC1” from the user table 140 in T38, and then specifies history information associated with the serial number “SN1” from the history table 144. Then, in T40 the SP server 100 calculates a plurality of print costs corresponding to the plurality of plans by using the number of printed sheets of each month in the trial period and the plan table 142. Details of the process of T40 will be described next.

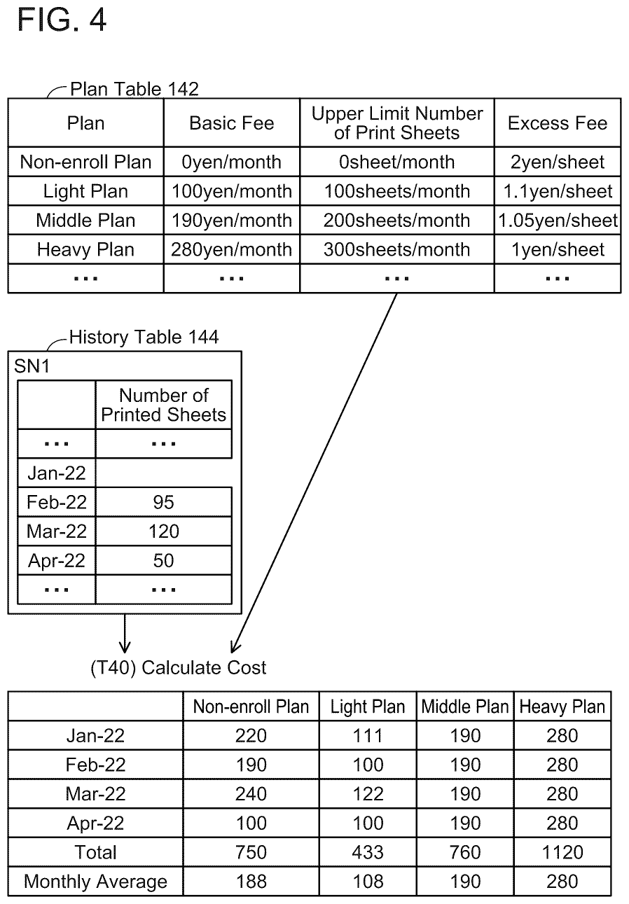

FIG. 4 shows the plan table 142 and the history table 144. In this example, the trial period is four months of January to April in 2022, and the history table 144 indicates the numbers of printed sheets of these four months. In T40, the SP server 100 firstly calculates the respective print costs corresponding the respective plans by using the number of printed sheets “110” of January and the respective information in the plan table 142. For example, the print cost for the non-enrollment plan is 220 yen (=110 sheets×excess fee 2 yen). The print cost for the light plan is 111 yen (=basic fee 100 yen+ (110 sheets-upper limit number of printed sheets 100 sheets)× excess fee 1.1 yen). The print cost for the middle plan is 190 yen (=basic fee 190 yen+0 sheets (110 sheets≤upper limit number of printed sheets 200 sheets)×excess fee 1.05 yen). The print cost for the heavy plan is 280 yen (=basic fee 280 yen+0 sheets (110 sheets≤ upper limit number of printed sheets 300 sheets)× excess fee 1 yen). Similarly, the SP server 100 calculates the print costs for the respective plans for each of February to April, calculates the total cost of the four months of each month, and calculates a monthly average cost for each plan. In the present case, the monthly average cost of the light plan is the lowest.

When the SP server 100 has calculated the above-mentioned respective costs, in T50 the SP server 100 sends result screen information representing a result screen SC1 including the total costs and the monthly average costs of the respective plans to the terminal device 50.

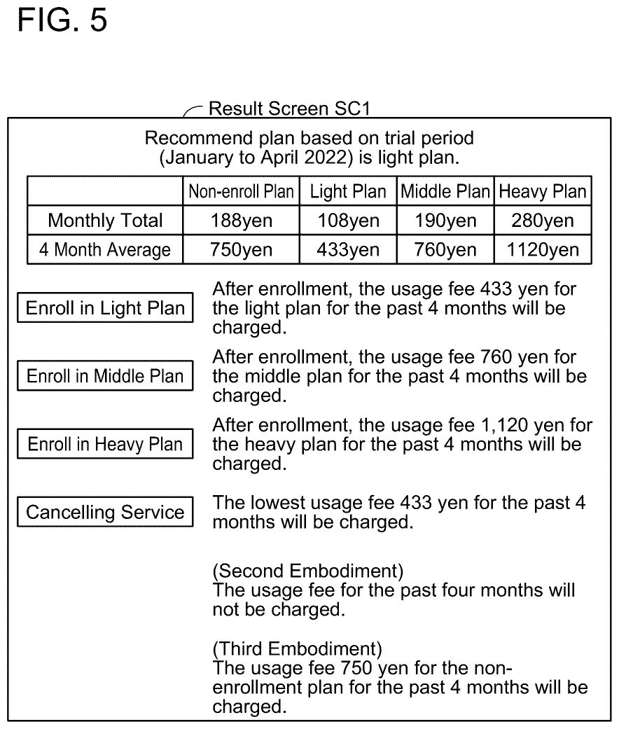

When the terminal device 50 receives the result screen information from the SP server 100 in T50, the terminal device 50 displays the result screen SC1 in T52. As shown in FIG. 5, the result screen SC1 includes a message indicating that a recommended plan based on the number of printed sheets in the trial period is the light plan and the monthly average costs and the total costs of the respective plans. Due to this, the user can easily acknowledge that the most cost-effective and recommended plan is the light plan.

The result screen SC1 further includes three enrollment buttons corresponding to the light plan, the middle plan, and the heavy plan and a service cancelling button. To the right of each enrollment button, a message indicating that the usage fee of the corresponding plan for the trial period will be charged if the user enrolls in the corresponding plan is shown. For example, since the total cost for the light plan is 433 yen, a message indicating that 433 yen will be charged if the user enrolls in the light plan is shown with the enrollment button corresponding to the light plan. Due to this, the user can acknowledge that the usage fee for the trial period will be charged if the user enrolls in the light plan, and acknowledge how much the usage fee is. Further, to the right of the service cancelling button, a message indicating that the lowest usage fee for the trial period will be charged is shown. In the present case, since the usage fee 433 yen for the light plan is the lowest, such message includes 433 yen. Due to this, the user can acknowledge that, if the user does not enroll in the subscription service, the usage fee for the trial period will be charged and acknowledge how much the usage fee is. In particular, it is likely that the user will enroll in the trial plan if a configuration with which the lowest usage fee will be charged is adopted.

In T54 of FIG. 3, the terminal device 50 receives selection of one of the four buttons on the result screen SC1 from the user. In this case, in T56, the terminal device 50 sends the selection information indicating the selected plan to the SP server 100. Here, in a case where the service cancelling button is selected in T52, the selection information indicates the non-enrollment plan.

When the SP server 100 receives the selection information from the terminal device 50 in T56, the SP server 100 executes a process corresponding to the selected plan in T58. For example, in a case where the selected plan is the light plan, the SP server 100 changes the contract plan information associated with the account information “AC1” from the trial plan to the light plan. Then, the SP server 100 charges the user 433 yen, the usage fee for the trial plan, by using the payment information “PI1”. The same applies to cases where the selected plan is the middle plan or the heavy plan, and thus the middle plan or the heavy plan is stored as the contract plan information, and 760 yen or 1120 yen is charged as the usage fee for the trial period. In a case where the selected plan is the non-enrollment plan, the SP server 100 changes the contract plan information associated with the account information “AC1” from the trial plan to the non-enrollment plan. Due to this, the CTG automatic shipping service is stopped. This means that the user cancels the service. Then, the SP server 100 charges the user 433 yen, the

### Effects of Present Embodiment

According to the present embodiment, the subscription service (specifically, CTG automatic shipping service) can be used in a state where the usage fee is not charged during the trial period. Due to this, user convenience can be improved.

### Correspondence Relationships

The SP server 100 and the printer 10 are an example of “controller” and “printer”, respectively. The terminal device 50 is an example of “display”. The result screen SC1 is an example of “selection screen”. One month is an example of “unit period”. The CTG automatic shipping service is an example of “predetermined service”. The light plan, the middle plan, and the non-enrollment plan are an example of “first print plan”, “second print plan”, and “third print plan”, respectively. The cost for the four months of the trial period is an example of “print cost”. The message about the recommended plan and the costs of the four months included in the result screen SC1 are an example of “related information”. The excess fee of the non-enrollment plan is an example of “fee per unit print amount”.

T40 in FIG. 3 is an example of process executed by “calculate a plurality of print costs”. T50 is an example of process executed by “display, on a display, a selection screen”. T58 is an example of process executed by “execute a first charge process”, “execute a second charge process”, and “execute a third charge process”.

### Second Embodiment; FIG. 5

A second embodiment will be described. In the present embodiment, as shown in the result screen SC1 in FIG. 5, to the right of the service cancelling button, a message indicating that the usage fee for the trial period will not be charged is shown. Due to this, the user can acknowledge that the usage fee for the trial period will not be charged even if the user does not enroll in the subscription service, and if a configuration with which the usage fee for the trial period is not charged is adopted as in the present case, it is easy for the user to enroll in the trial plan.

In a case where the selection information in T56 in FIG. 3 indicates the non-enrollment plan, in T58 the SP server 100 changes the contract plan information associated with the account information “AC1” from the trial plan to the non-enrollment plan but does not charge the usage fee for the trial period. The other processes are the same as those in the first embodiment.

### Third Embodiment; FIG. 5

A third embodiment will be described. In the present embodiment, as shown in the result screen SC1 in FIG. 5, a message indicating that 750 yen, the usage fee for the non-enrollment plan, will be charged is shown to the right of the service cancelling button. Due to this, the user can acknowledge that the usage fee for the trial period will be charged if the user does not enroll in the subscription service, and can acknowledge how much the usage fee is.

In a case where the selection information in T56 in FIG. 3 indicates the non-enrollment plan, in T58 the SP server 100 changes the contract plan information associated with the account information “AC1” from the trial plan to the non-enrollment plan, and charges the user 750 yen, the usage fee for the trial period, by using the payment information “PI1”. The other processes are the same as those in the first embodiment. In the present embodiment, the process of charging 750 yen, the usage fee for the non-enrollment plan in T58 is an example of process executed by “execute a fourth charge process”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

### Modification 1

The SP server 100 may be composed of a single server, or may be composed of plural servers. For example, the SP server 100 may be composed of a first server and a second server, in which the first server may execute the process of T14 and the second server may execute the processes from T22 in FIG. 3.

### Modification 2

“Unit period” may not be limited to one month, but may be another period such as one week, half a month, half year, and one year. The trial period may not be limited to four months, but may be a period shorter than four months, or may be a period of five months or longer. In general terms, the “predetermined period” may not be limited to four months, but simply needs to be a period of the unit period or longer.

### Modification 3

“Print history information” may not be limited to a number of printed sheets in a month, but may be a usage quantity of color material in a month (e.g., usage quantity of color material in a month converted into percent), and/or may be a number of color CTGs consumed in a month. In this case, the usage quantity of color material and/or the number of CTGs are examples of “print amount”.

### Modification 4

There may not be three types of plans, i.e., the light plan, the middle plan, and the heavy plan, but may be two types of plans, or may be only one type of plan. In the case where the one type of plan only exists, the non-enrollment plan and the above-mentioned one type of plan are an example of “plurality of print plans”. Further, in the case where the one type of plan only exists, in this plan, the basic fee and the upper limit number of printed sheets may not be set but a fee per printed sheet may be set. In general terms, “plurality of print plans” may not include a first print plan in which a first basic fee, a first upper limit value, and a first excess fee are predetermined.

### Modification 5

The excess fee may not be a fee that varies according to the number of printed sheets, but may be a fixed fee.

### Modification 6

The SP server 100 may not calculate the print cost with a state of not being enrolled in the service regarded as one print plan. That is, the non-enrollment plan may not be considered. In general terms, “plurality of print plans” may not include the third print plan.

### Modification 7

The result screen SC1 may not include the print costs corresponding to the respective print plans, but may include another information (e.g., a message) by which the user can understand a recommended plan. In general terms, “related information” may not include the plurality of print costs.

### Modification 8

The result screen SC1 may not include the message telling which plan is recommended. In general terms, “related information” may not include a message which recommends the user use a print plan corresponding to the lowest print cost.

### Modification 9

The printer 10 may be configured to store the plan table 142 and the history table 144 corresponding to the printer 10. In this case, in T10 in FIG. 4, the printer 10 updates the stored history table 144. That is, T12 and T14 are not executed. Further, instead of T20 to T52 the followings may be executed. When the printer 10 receives a predetermined operation after the trial period has ended, the printer 10 calculates the plurality of print costs by using the stored plan table 142 and the stored history table 144. This process is the same as T40 except that the printer 10 is the subject of action. The printer 10 then generates the result screen SC1, and displays the result screen SC1 on the display unit 14. In the present modification, the controller 30 of the printer 10 is an example of “control device”. In general terms, “control device” may not be a server configured separately from the printer.

### Modification 10

In the above-mentioned embodiments, the respective processes in FIG. 3 are realized by software, but at least one of these processes may be realized by hardware such as a logic circuitry.

What is claimed is:

1. A control device comprising a controller,
wherein the controller is configured to:
calculate a plurality of print costs corresponding to a plurality of print plans by using print history information of a printer in a predetermined period, wherein the predetermined period is a period during which a predetermined service related to the printer is used by a user but the user is not charged a usage fee for the predetermined service;
display, on a display, a selection screen including related information which is related to the plurality of calculated print costs, the selection screen being for selecting one print plan from among the plurality of print plans; and
in a case where a first print plan among the plurality of print plans is selected on the selection screen, execute a first charge process for charging the user a first print cost corresponding to the first print plan among the plurality of calculated print costs.

2. The control device as in claim 1, wherein, in the first print plan, a first basic fee required for a unit period, a first upper limit value related to a print amount within the unit period, and a first excess fee required when the print amount within the unit period exceeds the first upper limit value are predetermined.

3. The control device as in claim 1, wherein the plurality of print plans further includes a second print plan,
in the second print plan, a second basic fee required for the unit period, a second upper limit value related to a print amount within the unit period, and a second excess fee required when the print amount within the unit period exceeds the second upper limit value are predetermined,
the second basic fee is different from the first basic fee,
the second upper limit value is different from the first upper limit value, and
the second excess fee is different from the first excess fee,
wherein the controller is further configured to:
in a case where the second print plan is selected on the selection screen, execute a second charge process for charging the user a second print cost corresponding to the second print plan among the plurality of calculated print costs.

4. The control device as in claim 2, wherein the plurality of print plans further includes a third print plan, and
in the third print plan, a basic fee required for the unit period, an upper limit value related to a print amount within the unit period, and an excess fee required when the print amount within the unit period exceeds the upper limit value are not predetermined but a fee per unit print amount is predetermined,
wherein the controller is further configured to:
in a case where the third print plan is selected on the selection screen, execute a third charge process for charging the user a lowest print cost among the plurality of calculated print costs.

5. The control device as in claim 2, wherein the plurality of print plans further includes a third print plan,
in the third print plan, a basic fee required for the unit period, an upper limit value related to a print amount within the unit period, and an excess fee required when the print amount within the unit period exceeds the upper limit value are not predetermined but a fee per unit print amount is predetermined, and
in a case where the third print plan is selected on the selection screen, the user is not charged a print cost of the predetermined period.

6. The control device as in claim 2, wherein the plurality of print plans further includes a third print plan, and
in the third print plan, a basic fee required for the unit period, an upper limit value related to a print amount within the unit period, and an excess fee required when the print amount within the unit period exceeds the upper limit value are not predetermined but a fee per unit print amount is predetermined,
wherein the controller is further configured to:
in a case where the third print plan is selected on the selection screen, execute a fourth charge process for charging the user a third print cost corresponding to the third print plan among the plurality of calculated print costs.

7. The control device as in claim 1, wherein the print history information is a number of print media printed by the printer within a unit period.

8. The control device as in claim 1, wherein the related information includes the plurality of print costs.

9. The control device as in claim 1, wherein the related information includes a message which recommends the user use a print plan corresponding to a lowest print cost among the plurality of print costs.

10. The control device as in claim 1, wherein the control device is a server configured separately from the printer.

11. A non-transitory computer-readable storage medium storing computer-readable instructions for a control device, wherein
the computer-readable instructions, when executed by a processor of the control device, cause the communication device to:
calculate a plurality of print costs corresponding to a plurality of print plans by using print history information of a printer in a predetermined period, wherein the predetermined period is a period during which a predetermined service related to the printer is used by a user but the user is not charged a usage fee for the predetermined service;
display, on a display, a selection screen including related information which is related to the plurality of calculated print costs, the selection screen being for selecting one print plan from among the plurality of print plans; and
in a case where a first print plan among the plurality of print plans is selected on the selection screen, execute a first charge process for charging the user a first print cost corresponding to the first print plan among the plurality of calculated print costs.

12. A method executed by a control device, the method comprising:
calculating a plurality of print costs corresponding to a plurality of print plans by using print history information of a printer in a predetermined period, wherein the predetermined period is a period during which a predetermined service related to the printer is used by a user but the user is not charged a usage fee for the predetermined service;
displaying, on a display, a selection screen including related information which is related to the plurality of calculated print costs, the selection screen being for selecting one print plan from among the plurality of print plans; and
in a case where a first print plan among the plurality of print plans is selected on the selection screen, executing a first charge process for charging the user a first print cost corresponding to the first print plan among the plurality of calculated print costs.
